(19) United States
(12) Patent Application Publication
(10) Pub. No.: US 2019/0202278 A1
(43) Pub. Date: Jul. 4, 2019

(54) POWER TRANSMISSION SYSTEM OF HYBRID ELECTRIC VEHICLE

(71) Applicants: Hyundai Motor Company, Seoul (KR); Kia Motors Corporation, Seoul (KR)

(72) Inventors: Wan Soo Kim, Hwaseong-Si (KR); Shin Jong Kim, Hwaseong-si (KR); Won Il Lee, Hwaseong-si (KR); Youngchul Kim, Gwangmyeong-si (KR); Min Sung Kim, Seoul (KR); Yeongil Choi, Suwon-si (KR); Eui Cheol Chung, Seoul (KR); Taewon Kim, Seoul (KR); Seong Won Jeong, Bucheon-si (KR); Yeonho Kim, Suwon-si (KR); Kyungha Kim, Yongin-si (KR); Jae Hyuk Suh, Anyang-si (KR)

(73) Assignees: Hyundai Motor Company, Seoul (KR); Kia Motors Corporation, Seoul (KR)

(21) Appl. No.: 16/128,774

(22) Filed: Sep. 12, 2018

(30) Foreign Application Priority Data
Dec. 28, 2017 (KR) 10-2017-0182964

(51) Int. Cl. B60K 6/365; B60K 6/387; B60K 6/445; B60K 6/48

(52) U.S. Cl. CPC B60K 6/365; B60K 6/387; B60K 2006/381; B60K 6/48; B60K 6/445

(57) ABSTRACT

A power transmission system for a hybrid electric vehicle may include an input shaft to which a rotational power of an engine is input; a first motor/generator having a first motor shaft; a planetary gear set disposed on the first motor shaft of the first motor/generator and including a first rotation element fixedly connected to the first motor shaft, a second rotation element fixedly connected to the input shaft, and a third rotation element; a second motor/generator having a second motor shaft disposed; and an output shaft transmitting a rotational power transmitted from the planetary gear set and the second motor/generator to a differential apparatus, wherein the rotational driving force of the planetary gear set and the second motor/generator is transmitted to the output shaft by the first gear set and the rotational driving force of the output shaft is transmitted to the differential apparatus by the second gear set.

### CROSS-REFERENCE TO RELATED APPLICATION

The present application claims priority to Korean Patent Application No. 10-2017-0182964 filed on Dec. 28, 2017, the entire contents of which is incorporated herein for all purposes by this reference.

### BACKGROUND OF THE INVENTION

### Field of the Invention

The present invention relates to a power transmission system for a hybrid electric vehicle. More particularly, the present invention relates to a power transmission system for a hybrid electric vehicle for improving fuel consumption by allowing an overdrive running by an engine driving in high speed driving region.

### Description of Related Art

An environmentally-friendly technology of a vehicle is a core technology which controls survival of a future vehicle industry, and advanced vehicle makers have focused on the development of an environmentally-friendly vehicle to achieve environmental and fuel efficiency regulations.

Therefore, vehicle makers have developed an electric vehicle (EV), a hybrid electric vehicle (HEV), a fuel cell electric vehicle (FCEV), and the like, as future vehicle technologies.

Since the future vehicle has various technological restrictions such as a weight and cost, the vehicle makers have paid attention to the hybrid electric vehicle as an alternative of a realistic problem for meeting exhaust gas regulations and improving fuel efficiency performance and have entered into keen competition for commercializing the hybrid electric vehicle.

The hybrid electric vehicle is a vehicle using two or more power sources, two or more power sources may be combined by various schemes, and a gasoline engine or a diesel engine using the existing fossil fuel and a motor/generator driven by electrical energy are mixed and used as the power sources.

In the hybrid electric vehicle, an electric vehicle (EV) mode in which the hybrid electric vehicle is driven by only the motor/generator, a hybrid electric vehicle (HEV) mode using both the engine and the motor/generator, and an ENG mode using only the engine may be implemented according to the combination of the engine and the motor, and the hybrid electric vehicle can acquire a significant fuel efficiency enhancement effect as compared with the conventional vehicle through idle stop of stopping the engine when the vehicle stops, fuel saving by regenerative braking that drives a generator by use of kinetic energy of the vehicle instead of braking by the existing friction when the vehicle is braked, and stores in a battery electrical energy generated at the time of driving the generator and reuses the stored electrical energy in driving the vehicle, and the like.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a power transmission system for a hybrid electric vehicle for improving a fuel consumption by allowing an overdrive running by an engine driving in high speed driving region.

Various aspects of the present invention are directed to providing a power transmission system for a hybrid electric vehicle for improving a mountability by disposing a one-way clutch preventing a reverse rotation of a planet carrier on an external circumference side of a planetary gear set to reduce a whole length.

A power transmission system for a hybrid electric vehicle according to an exemplary embodiment of the present invention may include an input shaft to which a rotational power of an engine is input; a first motor/generator disposed on the same axis as the input shaft and having a first motor shaft; a planetary gear set disposed on the first motor shaft of the first motor/generator and including a first rotation element fixedly connected to the first motor shaft, a second rotation element fixedly connected to the input shaft, and a third rotation element; a second motor/generator having a second motor shaft disposed to be parallel to the input shaft at a predetermined interval; and an output shaft disposed in parallel between the input shaft and a second motor shaft of the second motor/generator and transmitting a rotational power transmitted from the planetary gear set and the second motor/generator to a differential apparatus, wherein the rotational driving force of the planetary gear set and the second motor/generator is transmitted to the output shaft by the first gear set and the rotational driving force of the output shaft is transmitted to the differential apparatus by the second gear set.

The planetary gear set may be a single pinion planetary gear set, a first rotation element may be a sun gear, a second rotation element may be a planet carrier, and a third rotation element may be a ring gear, and the third rotation element may be operably connected to the first gear set to transmit the rotational power of the planetary gear set to the first gear set.

The sun gear may be selectively connectable to a transmission housing through a brake, and the planet carrier is connected to the transmission housing through a one-way clutch.

The first gear set may include an intermediate output gear rotatably dispose on the input shaft and fixedly connected to the ring gear of the planetary gear set, an output shaft input gear fixedly disposed on the output shaft and meshed with the intermediate output gear, and a motor shaft gear fixedly disposed on the second motor shaft of the second motor/generator and meshed with the output shaft input gear, and the second gear set may include an output shaft output gear fixedly disposed on the output shaft and a differential ring gear of the differential apparatus meshed with the output shaft output gear.

A power transmission system for a hybrid electric vehicle according to another exemplary embodiment of the present invention may include an input shaft to which a rotational power of an engine is input; a first motor/generator having a first motor shaft disposed on the same axis as the input shaft; a planetary gear set disposed on the first motor shaft of the first motor/generator and including a first rotation element fixedly connected to the first motor shaft, a second rotation element fixedly connected to the input shaft, and a third rotation element; a second motor/generator having a second motor shaft disposed to be parallel to the first motor shaft at a predetermined interval; and an output shaft disposed in parallel between the input shaft and the second motor shaft and transmitting the rotational power transmitted from the third rotation element of the planetary gear set and the second motor shaft to the differential apparats; a first gear set including an intermediate output gear rotatably disposed on the input shaft and fixedly connected to the third rotation element of the planetary gear set, an output shaft input gear fixedly disposed on the output shaft and meshed with the intermediate output gear, and a motor shaft gear fixedly disposed on the second motor shaft and meshed with the output shaft input gear; and a second gear set including an output shaft output gear fixedly disposed on the output shaft and a differential ring gear of the differential apparatus meshed with the output shaft output gear.

The planetary gear set may be a single pinion planetary gear set, a first rotation element may be a sun gear, a second rotation element may be a planet carrier, and a third rotation element may be a ring gear, and the ring gear may be fixedly connected to the intermediate output gear.

The sun gear may be selectively connectable to a transmission housing through a brake, and the planet carrier may be connected to the transmission housing through a one-way clutch.

In the power transmission system for the hybrid electric vehicle according to an exemplary embodiment of the present invention, as the overdrive (OD) due to the engine driving is possible in the high speed driving region, the fuel consumption may be improved.

Also, as an exemplary embodiment of the present invention disposes the one-way clutch preventing the reverse rotation of the planet carrier on the external circumference side of the planetary gear set, the whole length may be reduced, improving the mountability.

Also, as the power transmission system for the hybrid electric vehicle according to an exemplary embodiment of the present invention combines the rotational driving forces of the engine and the first motor/generator in the hybrid mode to be output, since all rotational driving forces generated when driving the engine may be used, a maximum power performance may be demonstrated.

Also, in the power transmission system for the hybrid electric vehicle according to an exemplary embodiment of the present invention, the torque assistance of the second motor/generator may be done in the hybrid mode and the engine mode.

Furthermore, effects which may be obtained or expected from exemplary embodiments of the present invention are directly or suggestively described in the following detailed description. That is, various effects expected from exemplary embodiments of the present invention will be described in the following detailed description.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a power transmission system for a hybrid electric vehicle according to an exemplary embodiment of the present invention.

FIG. 2 is an operation mode diagram in each mode of a power transmission system for a hybrid electric vehicle according to an exemplary embodiment of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Exemplary embodiments of the present application will be described more fully hereinafter with reference to the accompanying drawings, in which exemplary embodiments of the present invention are shown. As those skilled in the art would realize, the described embodiments may be modified in various different ways, all without departing from the spirit or scope of the present invention.

The drawings and description are to be regarded as illustrative in nature and not restrictive, and like reference numerals designate like elements throughout the specification.

In the following description, dividing names of components into first and second and the like is to divide the names because the names of the components are the same as each other and an order thereof is not particularly limited.

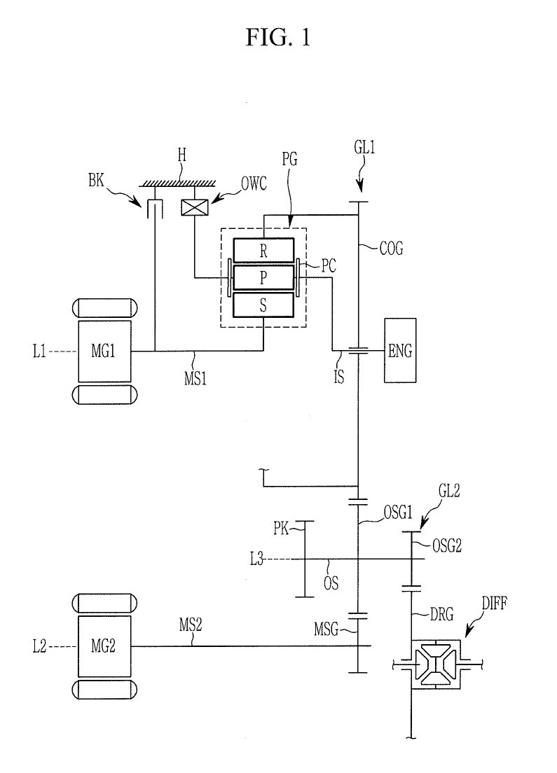

FIG. 1 is a schematic diagram of a power transmission system for a hybrid electric vehicle according to an exemplary embodiment of the present invention.

Referring to FIG. 1, the power transmission system for the hybrid electric vehicle according to an exemplary embodiment of the present invention utilizes an engine ENG and first and second motor/generators MG1 and MG2 as a power source. The power transmission system includes an input shaft IS, a planetary gear set PG receiving a rotational driving force of the engine ENG and the rotational driving force of the first motor/generator MG1, and an output shaft OS transmitting the rotational driving force transmitted from the planetary gear set PG and the second motor/generator MG to a differential apparatus DIFF

The engine ENG as a primary power source may use various kind of typical engines such as a gasoline engine or a diesel engine that utilizes fossil fuel.

The first and second motor/generators MG1 and M2 perform both function of a motor and a generator as known in the art, and each of the motor/generators MG1 and M2 may include a stator fixed to a transmission housing H and a rotor supported to be rotatably inside a radial direction of the stator.

The planetary gear set PG is a single pinion planetary gear set and includes a sun gear S, a planet carrier PC rotatably supporting a plurality of pinion gear P engaged with the sun gear, and a ring gear R engaged with the plurality of pinion gears P and operably connected to the sun gear S.

The engine ENG, the input shaft IS, the first and second motor/generators MG1 and MG2, the planetary gear set PG, and the output shaft OS are dispersed and disposed on first and second, third axes L1, L2, and L3 disposed to be mutually parallel at a predetermined interval and are operably connected by two gear sets GL1 and GL2.

The engine ENG, the planetary gear set PG, the first motor/generator MG1 are sequentially disposed on the first axis L1. The input shaft IS connected to an output side (or a crank shaft) of the engine ENG and a first motor shaft MS1 of the first motor/generator MG1 are disposed on the first axis L1.

The planetary gear set PG is disposed on the first motor shaft MS1. The planetary gear set PG includes a sun gear S, a planet carrier PC rotatably supporting a plurality of pinion gears P engaged to the sun gear S, and a ring gear R engaged to the plurality of pinion gears P and operably connected to the sun gear S as a rotation element. The sun gear S is fixedly connected to the first motor shaft MS1 and is selectively connectable to the transmission housing H through a brake BK. Also, the planet carrier PC is fixedly connected to the input shaft IS and is connected to the transmission housing H through a one-way clutch OWC. The one-way clutch OWC allows the planet carrier PC to be rotated only in predetermined one direction and prevents from being rotated in the opposite direction thereof. The ring gear R is operated as an output element.

The planetary gear set PG combines the rotation speed of the first motor/generator MG1 input to the sun gear S and the rotational power of the engine ENG input to the planet carrier PC to output the combined rotation speed to the ring gear R.

The second motor/generator MG2 disposed on the second axis L2 and the second motor/generator MG2 includes a second motor shaft MS2.

The output shaft OS is disposed on the third axis L3. The output shaft OS is operably connected to the ring gear R of the planetary gear set PG and the second motor shaft MS2 by a first gear set GL1 and is operably connected to the differential apparatus DIFF by a second gear set GL2.

The first gear set GL1 includes an intermediate output gear COG rotatably disposed on the input shaft IS and fixedly connected to the ring gear R of the planetary gear set PG, an output shaft input gear OSG1 fixedly disposed on the output shaft OS and meshed with the intermediate output gear COG, and a motor shaft gear MSG fixedly disposed on the second motor shaft MS2 and meshed with the output shaft input gear OSG1.

The second gear set GL2 includes an output shaft output gear OSG2 fixedly disposed on the output shaft OS and a differential ring gear DRG fixedly connected to the differential apparatus DIFF and meshed with the output shaft output gear OSG2.

Here, “a gear is fixedly disposed on a shaft” means that a corresponding gear is always rotated in the same direction with the same rotation speed as a corresponding shaft. Also, “a gear is rotatably disposed on a shaft” means that a corresponding gear is relatively rotated with a corresponding shaft.

A gear ratio of each gear included in two gear sets GL1 and GL2 may be set according to a design condition of the corresponding power delivery apparatus.

The brake BK as a hydraulic pressure friction engagement device operated by a hydraulic pressure supplied from a hydraulic pressure control apparatus may mainly use a multi-plate type hydraulic pressure friction engagement device of a wet type.

In FIG. 1, a reference numeral “PK” is a parking gear.

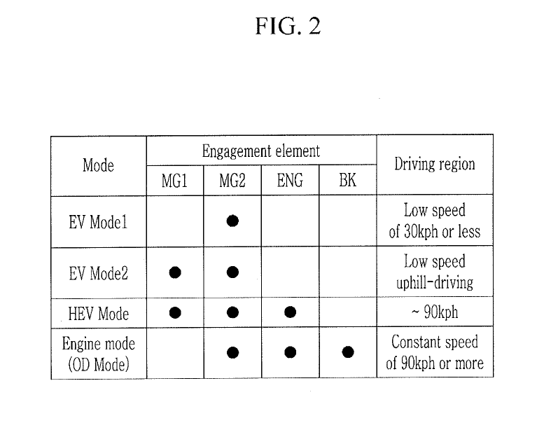

FIG. 2 is an operation mode diagram in each mode of a power transmission system for a hybrid electric vehicle according to an exemplary embodiment of the present invention.

Referring to FIG. 2, the power transmission system may realize four operation modes depending on an operation of the engine ENG, an operation of the first and second motor/generators MG1 and MG2, and an operation of the brake BK. Four operation modes are described in detail.

### First Electric Vehicle Mode

In the first electric vehicle mode (EV mode 1), the brake BK is not operated, the engine ENG and the first motor/generator MG1 are also not driven, and the second motor/generator MG2 is driven.

The rotational power of the second motor/generator MG is transmitted to the differential ring gear DRG of the differential apparatus DIFF through the second motor shaft MS2, the motor shaft gear MSG, the output shaft input gear OSG1, the output shaft OS, and the output shaft output gear OSG2. Accordingly, the vehicle may run in the first electric vehicle mode (EV mode 1).

It is desirable to operate such first electric vehicle mode (EV mode 1) in a low speed driving region that the vehicle speed is 30 kph or less.

Also, if the second motor/generator MG2 is reversely rotated, the vehicle may move backward thereof.

### Second Electric Vehicle Mode

In the second electric vehicle mode (EV mode 2), the brake BK is not operated, and the engine ENG is not also driven, and the first and second motor/generators MG1 and MG2 are driven.

The rotational power of the first motor/generator MG1 is input to the sun gear S, however the planet carrier PC of the planetary gear set PG is operated as a fixed element by the one-way clutch OWC. Accordingly, the rotational power of the first motor/generator MG1 is input to the output shaft input gear OSG1 through the intermediate output gear COG fixedly connected to the ring gear R and is combined with the rotational power of the second motor/generator MG2 in the output shaft input gear OSG1. The combined rotational power is transmitted to the differential ring gear DRG of the differential apparatus DIFF through the output shaft OS and the output shaft output gear OSG2. Accordingly, the vehicle may run in the second electric vehicle mode (EV mode 2).

As the first and second motor/generators MG1 and MG2 are driven in the EV mode 2, it is desirable to be operated in low speed uphill-driving requiring large power. It may be preferable that the second electric vehicle mode (EV mode 2) is operated in a low speed uphill-driving requiring large power since the first and second motor/generators MG1 and MG2 are all driven.

### Hybrid Mode

In the hybrid mode (HEV mode), the brake BK is not operated, and the engine ENG and the first and second motor/generators MG1 and MG2 are all driven.

The rotational power of the engine ENG is input to the planet carrier PC of the planetary gear set PG through the input shaft IS, and the rotational power of the first motor/generator MG1 is input to the sun gear S.

In the planetary gear set PG, a power split is generated by a rotation speed difference of the sun gear S and the planet carrier PC. Accordingly, the rotational power of the engine ENG and the first motor/generator MG1 is input to the output shaft input gear OSG1 through the intermediate output gear COG fixedly connected to the ring gear R and is combined with the rotational power of the second motor/generator MG2 in the output shaft input gear OSG1. The combined rotational power is transmitted to the differential ring gear DRG of the differential apparatus DIFF through the output shaft OS and the output shaft output gear OSG2. Accordingly, the vehicle may run in the hybrid mode (HEV mode).

In the instant case, as the second motor/generator MG2 is driven for torque assistance, it may not necessarily be driven.

### Engine Mode (OD Mode)

In the engine mode, the brake BK is operated and the engine ENG is driven.

Thus, the brake BK is operated in a state that the rotational power of the engine ENG is input to the planet carrier PC through the input shaft IS. Accordingly, the rotation speed of the engine ENG increases in the planetary gear set PG and the increased rotation speed is input to the output shaft input gear OSG1 through the ring gear R and the intermediate output gear COG.

The increased rotation speed input to the output shaft input gear OSG1 is combined with the rotational power of the second motor/generator MG2, and the combined rotational power is transmitted to the differential ring gear DRG of the differential apparatus DIFF through the output shaft OS and the output shaft output gear OSG2. Accordingly, the vehicle may run in the engine mode.

In the instant case, as the second motor/generator MG2 is driven for torque assistance, it may not necessarily be driven.

As above-described, in the power transmission system for the hybrid electric vehicle according to an exemplary embodiment of the present invention, as the overdrive (OD) driving due to the engine driving is possible in the high speed driving region, the fuel consumption may be improved.

Also, as an exemplary embodiment of the present invention disposes the one-way clutch preventing the reverse rotation of the planet carrier on the external circumference side of the planetary gear set, the whole length may be reduced, improving the mountability.

Also, as an exemplary embodiment of the present invention joins the rotational driving forces of the engine and the first motor/generator in the hybrid mode (HEV mode) to be output, since all rotational driving forces generated when driving the engine may be used, a maximum power performance may be demonstrated.

Also, in an exemplary embodiment of the present invention, the torque assistance of the second motor/generator may be done in the hybrid mode (HEV mode) and the engine mode.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A power transmitting system for a hybrid electric vehicle, the system comprising:
an input shaft to which a rotational power of an engine is input;
a first motor/generator disposed on a same axis as the input shaft and having a first motor shaft;
a planetary gear set disposed on the first motor shaft of the first motor/generator and including a first rotation element fixedly connected to the first motor shaft, a second rotation element fixedly connected to the input shaft, and a third rotation element;
a second motor/generator having a second motor shaft disposed to be parallel to the input shaft at a predetermined interval with the input shaft; and
an output shaft disposed in parallel with and disposed between the input shaft and the second motor shaft of the second motor/generator and transmitting a rotational power transmitted from the planetary gear set and the second motor/generator to a differential apparatus,
wherein a rotational driving force of the planetary gear set and the second motor/generator is transmitted to the output shaft by the first gear set and a rotational driving force of the output shaft is transmitted to the differential apparatus by the second gear set.

2. The power transmitting system for the hybrid electric vehicle of claim 1,
wherein the planetary gear set is a single pinion planetary gear set, the first rotation element is a sun gear, the second rotation element is a planet carrier engaged with the sun gear, and the third rotation element is a ring gear engaged with the planet carrier, and
wherein the third rotation element is engaged to the first gear set to transmit the rotational power of the planetary gear set to the first gear set.

3. The power transmitting system for the hybrid electric vehicle of claim 2,
wherein the sun gear is selectively connectable to a transmission housing through a brake, and
wherein the planet carrier is connected to the transmission housing through a one-way clutch.

4. The power transmitting system for the hybrid electric vehicle of claim 2,
wherein the first gear set includes an intermediate output gear rotatably disposed on the input shaft and fixedly connected to the ring gear of the planetary gear set, an output shaft input gear fixedly disposed on the output shaft and engaged with the intermediate output gear, and a motor shaft gear fixedly disposed on the second motor shaft of the second motor/generator and meshed with the output shaft input gear, and
wherein the second gear set includes an output shaft output gear fixedly disposed on the output shaft and a differential ring gear of the differential apparatus, wherein the differential ring gear is engaged with the output shaft output gear.

5. The power transmitting system for the hybrid electric vehicle of claim 1, further including a parking gear fixedly mounted to the output shaft.

6. A power transmitting system for a hybrid electric vehicle, the system comprising:
an input shaft to which a rotational power of an engine is input;
a first motor/generator having a first motor shaft disposed on a same axis as the input shaft;
a planetary gear set disposed on the first motor shaft of the first motor/generator and including a first rotation element fixedly connected to the first motor shaft, a second rotation element fixedly connected to the input shaft, and a third rotation element;
a second motor/generator having a second motor shaft disposed to be in parallel to the first motor shaft at a predetermined interval with the first motor shaft; and
an output shaft disposed in parallel with and disposed between the input shaft and the second motor shaft and transmitting a rotational power transmitted from the third rotation element of the planetary gear set and the second motor shaft to a differential apparatus;
a first gear set including an intermediate output gear rotatably disposed on the input shaft and fixedly connected to the third rotation element of the planetary gear set, an output shaft input gear fixedly disposed on the output shaft and engaged with the intermediate output gear, and a motor shaft gear fixedly disposed on the second motor shaft and engaged with the output shaft input gear; and
a second gear set including an output shaft output gear fixedly disposed on the output shaft and a differential ring gear of the differential apparatus, wherein the differential ring gear is engaged with the output shaft output gear.

7. The power transmitting system for the hybrid electric vehicle of claim 6,
wherein the planetary gear set is a single pinion planetary gear set, the first rotation element is a sun gear, the second rotation element is a planet carrier engaged with the sun gear, and the third rotation element is a ring gear engaged with the planet carrier, and
wherein the ring gear is fixedly connected to the intermediate output gear.

8. The power transmitting system for the hybrid electric vehicle of claim 6,
wherein the sun gear is selectively connectable to a transmission housing through a brake, and
wherein the planet carrier is connected to the transmission housing through a one-way clutch.

9. The power transmitting system for the hybrid electric vehicle of claim 6, further including a parking gear fixedly mounted to the output shaft.
